(19) United States
(12) Patent Application Publication
(10) Pub. No.: US 2025/0327675 A1
(43) Pub. Date: Oct. 23, 2025

(54) COMPUTER-IMPLEMENTED NAVIGATION METHOD AND SYSTEM, ELECTRONIC DEVICE, NONVOLATILE COMPUTER READABLE STORAGE MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Youxiang XIA, Beijing (CN); Shuobin LIANG, Beijing (CN); Honglei ZHANG, Beijing (CN); Xiao CHU, Beijing (CN); Hongbo FENG, Beijing (CN); Yangyang ZHANG, Beijing (CN)

(21) Appl. No.: 19/252,112

(22) Filed: Jun. 27, 2025

Related U.S. Application Data
(63) Continuation-in-part of application No. 18/028,056, filed on Mar. 23, 2023, now Pat. No. 12,366,454.

(51) Int. Cl. G01C 21/34

(52) U.S. Cl. CPC G01C 21/3415

(57) ABSTRACT

The present disclosure provides a navigation method applied to a cloud server. The method includes: determining a global route between a starting point and a destination in response to navigation request information transmitted by a mobile terminal, the navigation request information includes at least information of starting point and destination; transmitting the global route to the mobile terminal to guide the user to drive according to the global route; acquiring a current position of the mobile terminal in response to road abnormality information transmitted by the mobile terminal in the driving process of the user; acquiring a shared route in the cloud server, and generating at least one corrected route from the current position to the destination; the corrected route is different from an original remaining route. The present disclosure also provides a cloud server, a mobile terminal, a navigation system, an electronic device, and a computer-readable medium.

### CROSS REFERENCE TO RELATED APPLICATIONS

This is a Continuation-In-Part of U.S. patent application Ser. No. 18/028,056, filed on Mar. 23, 2023, which is a National Phase Application filed under 35 U.S.C. 371 as a national stage of PCT/CN2022/083648 filed on Mar. 29, 2022, the entire contents of which are incorporated herein by reference.

### TECHNICAL FIELD

The present disclosure relates to the field of vehicle networking technology, and in particular to a navigation method, a navigation system, an electronic device and a nonvolatile computer readable storage medium.

### BACKGROUND

Currently, the automatic driving or the manual driving can't do without the map navigation, and a planned route is based on map information stored in a system.

However, in some cases, the map information is not updated timely due to uncertain factors such as temporary road repair or the like, so that the planned driving route cannot avoid an impassable road, which affects the driving experience of a user.

### SUMMARY

The present disclosure is directed to at least one of the technical problems in the prior art, and provides a navigation method, a cloud server, a mobile terminal, a navigation system, an electronic device, and a computer-readable medium.

To achieve the above objects, the present disclosure provides a navigation method for a cloud server, including: determining a global route between a starting point and a destination in response to navigation request information transmitted by a mobile terminal, the navigation request information includes at least information regarding the starting point and the destination; transmitting the global route to the mobile terminal, to guide a user to drive according to the global route; acquiring a current position of the mobile terminal in response to road abnormality information transmitted by the mobile terminal in the driving process of the user; and acquiring a shared route in the cloud server, and generating at least one corrected route from the current position to the destination; wherein the corrected route is different from an original remaining route, and the original remaining route is a part of the global route between the current position of the mobile terminal and the destination.

In some embodiments, the acquiring the shared route in the cloud server, and generating the at least one corrected route from the current position to the destination, includes: acquiring at least one related route passing through the current position and a target node from the shared route in the cloud server, wherein the target node is the destination or a key road node positioned on the original remaining route; taking a portion of the related route between the current position and the target node as the corrected route when the target node is the destination; and generating the corrected route according to the portion of the related route between the current position and the target node and the portion of the original remaining route between the target node and the destination when the target node is the key road node.

In some embodiments, before the acquiring the at least one related route passing through the current position and the target node, the navigation method further includes: detecting whether the abnormal road segment exists on the original remaining route; and detecting the region where the abnormal road segment is located in response to the abnormal road segment existing on the original remaining route; and wherein the target node passed by the related route is located outside the abnormal road segment.

In some embodiments, the navigation method further includes: acquiring road condition information of the original remaining route and road condition information of each corrected route; determining estimated passing time for the original remaining route according to the road condition information of the original remaining route; determining the estimated passing time for each corrected route according to the road condition information of each corrected route; determining average passing time of all the corrected routes according to the estimated passing time for each corrected route; and transmitting the at least one corrected route to the mobile terminal in response to a ratio of the estimated passing time to the average passing time for the original remaining route exceeds a preset threshold.

In some embodiments, the transmitting the at least one corrected route to the mobile terminal, includes: selecting one of all the corrected routes as a recommended route according to a preset rule, and transmitting the recommended route to the mobile terminal.

In some embodiments, the transmitting the at least one corrected route to the mobile terminal, includes: transmitting all the corrected routes to the mobile terminal; selecting one of all the corrected routes as a recommended route in response to route selection information transmitted by the mobile terminal; and transmitting the recommended route to the mobile terminal.

In some embodiments, the navigation method further includes: generating a characteristic tag of each corrected route according to the road condition information of each corrected route; and wherein when all the corrected routes are transmitted to the mobile terminal, the characteristic tag of each corrected route is transmitted to the mobile terminal;

In some embodiments, when the ratio of the estimated passing time to the average passing time of the original remaining route exceeds the preset threshold, the navigation method further includes: generating reminding information according to the estimated passing time and the average passing time of the original remaining route, and transmitting the reminding information to the mobile terminal.

In some embodiments, the determining the global route between the starting point and the destination, includes: determining the global route between the starting point and the destination according to map information stored in the cloud server.

In some embodiments, the determining the global route between the starting point and the destination, includes: determining a first alternative global route between the starting point and the destination according to the map information stored in the cloud server; selecting at least one second alternative global route from a plurality of shared routes in the cloud server, wherein the second alternative global route passes through a region defined by taking the destination as a center and a preset value as a radius; and fitting the first alternative global route and at least one second alternative global route to obtain the global route.

In some embodiments, the navigation request information further includes: position information of at least one intermediate node between the starting point and the destination; the determining the global route between the starting point and the destination, including: determining the first alternative global route between the starting point and the destination according to the map information stored in the cloud server; judging whether the first alternative global route passes through each intermediate node; taking the first alternative global route as the global route, in response to the first alternative global route passing through each intermediate node; and selecting at least one second alternative global route from the plurality of shared routes in the cloud server; and fitting the at least one second alternative global route with the first alternative global route to generate the global route passing through each intermediate node, in response to the first alternative global route not passing through each intermediate node.

In some embodiments, the navigation method further includes: updating the stored map information according to the route shared by the mobile terminal in response to navigation end information.

An embodiment of the present disclosure further provides a navigation method for a mobile terminal, the navigation method includes: transmitting navigation request information to a cloud server according to navigation instruction input by a user, so that the cloud server determines a global route between a starting point and a destination; the navigation request information includes at least information regarding the starting point and the destination; receiving the global route transmitted by the cloud server; and transmitting road abnormality information to the cloud server in response to driving abnormality stop information, so that the cloud server acquires a current position of the mobile terminal and a shared route in the cloud server in response to the road abnormality information to generate at least one corrected route from the current position to the destination; wherein the at least one corrected route is different from an original remaining route, the original remaining route is a portion of the global route between the current position and the destination.

In some embodiments, the navigation method further includes: receiving the corrected route transmitted by the cloud server; outputting an instruction acquisition request to request the user to input a selection instruction; transmitting route selection information to the cloud server in response to the selection instruction input by the user, so that the cloud server selects one of all the corrected routes as the recommended route; and receiving the recommended route transmitted by the cloud server.

In some embodiments, the navigation method further includes: outputting shared request information in response to navigation end information; and transmitting at least a part of an actual driving route to the cloud server in response to confirmation sharing information input by the user.

An embodiment of the present disclosure further provides a cloud server, including: a global route determining module configured to determine a global route between a starting point and a destination in response to navigation request information transmitted by a mobile terminal, the navigation request information includes at least information regarding the starting point and the destination; a global route transmitting module configured to transmit the global route to the mobile terminal to guide a user to drive according to the global route; and a corrected route generating module configured to acquire a current position of the mobile terminal in response to road abnormality information transmitted by the mobile terminal in the driving process of the user; acquire a shared route in the cloud server, and generate at least one corrected route from the current position to the destination; wherein the corrected route is different from an original remaining route, and the original remaining route is a part of the global route between the current position of the mobile terminal and the destination.

An embodiment of the present disclosure further provides a mobile terminal, including: a request transmitting module configured to transmit navigation request information to a cloud server according to navigation instruction input by a user, so that the cloud server determines a global route between a starting point and a destination; the navigation request information includes at least information regarding the starting point and the destination; a route receiving module configured to receive the global route transmitted by the cloud server; an abnormality information transmitting module configured to transmit road abnormality information to the cloud server in response to driving abnormality stop information, so that the cloud server acquires a current position of the mobile terminal in response to the road abnormality information, acquire a shared route in the cloud server, and generate at least one corrected route from the current position to the destination; and wherein the corrected route is different from an original remaining route, and the original remaining route is a part of the global route between the current position of the mobile terminal and the destination.

An embodiment of the present disclosure further provides a navigation system, including: the cloud server and the mobile terminal.

An embodiment of the present disclosure further provides an electronic device, including: one or more processors; a memory having one or more programs stored thereon which, when executed by the one or more processors, cause the one or more processors to implement the method; and one or more I/O interfaces connected between the one or more processors and the memory and configured to enable information interaction between the one or more processors and the memory.

An embodiment of the present disclosure further provides a computer-readable medium, on which a computer program is stored, and implements the above method when executed by a processor.

### BRIEF DESCRIPTION OF DRAWINGS

The accompanying drawings, which are provided for further understanding of embodiments of the present disclosure and constitute a part of this specification, are for explaining the present disclosure together with the embodiments of the present disclosure, but are not intended to limit the present disclosure. In the drawings:

FIG. 1 is a schematic flow chart of a navigation method provided in some embodiments of the present disclosure.

FIG. 2 is a schematic flow chart of a navigation method provided in further embodiments of the present disclosure.

FIG. 3 is a schematic flow chart of step S11 provided in one example of the present disclosure.

FIG. 4 is a schematic flow chart of step S11 provided in another example of the present disclosure.

FIG. 5 is a schematic flow chart of step S11 provided in yet another example of the present disclosure.

FIG. 6 is a schematic flow chart of step S14 provided in some embodiments of the present disclosure.

FIG. 7 is a schematic diagram of a global route and a corrected route provided in one example of the present disclosure.

FIG. 8 is a schematic diagram of a global route and a corrected route provided in another example of the present disclosure.

FIG. 9 is a schematic flow chart of a navigation method provided in further embodiments of the present disclosure.

FIG. 10 is a schematic flow chart of a navigation method implemented by a navigation system provided in some embodiments of the present disclosure.

FIG. 11 is a schematic diagram of a cloud server provided in some embodiments of the present disclosure.

FIG. 12 is a schematic diagram of a mobile terminal provided in some embodiments of the present disclosure.

FIG. 13 is a schematic diagram of a navigation system provided in some embodiments of the present disclosure.

FIG. 14 is a schematic diagram of an electronic device provided in some embodiments of the present disclosure.

FIG. 15 is a flow chart of a computer-implemented navigation method provided in some embodiments of the present disclosure.

FIG. 16 is a flow chart of a computer-implemented navigation method provided in some embodiments of the present disclosure.

### DETAIL DESCRIPTION OF EMBODIMENTS

In order to enable one of ordinary skill in the art to better understand the technical solutions of the present disclosure, the present disclosure will be described in further detail with reference to the accompanying drawings and the detailed description.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term of “comprising”, “including”, or the like, means that the element or item preceding the term contains the element or item listed after the term and its equivalent, but does not exclude other elements or items.

The embodiment of the present disclosure provides a navigation method, which is applied to a navigation system, the navigation system includes a cloud server and a mobile terminal communicating with the cloud server, and the mobile terminal may be a vehicle-mounted terminal, a mobile phone or the like.

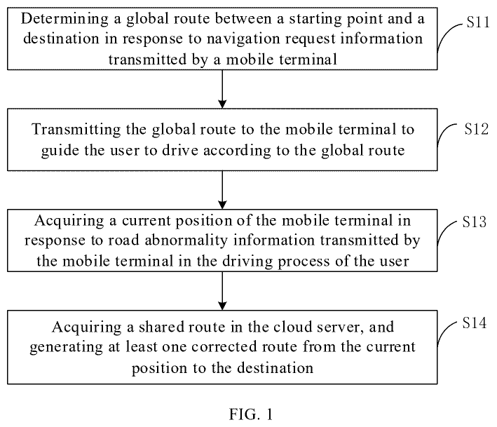

FIG. 1 is a schematic flow chart of a navigation method provided in some embodiments of the present disclosure. The navigation method shown in FIG. 1 is applied to a cloud server, and as shown in FIG. 1, the navigation method includes the following steps S11 to S14 performed by the cloud server:

S11, determining a global route between a starting point and a destination in response to navigation request information transmitted by a mobile terminal, wherein the navigation request information includes at least information regarding the starting point and the destination.

The navigation request information may be generated by the mobile terminal according to information such as addresses of the starting point and the destination input by the user. The cloud server may generate the global route from a built-in map.

S12, transmitting the global route to the mobile terminal, to guide the user to drive according to the global route.

S13, acquiring a current position of the mobile terminal in response to road abnormality information transmitted by the mobile terminal in the driving process of the user.

The road abnormality information may be information transmitted by the mobile terminal when an abnormality occurs on the road ahead (for example, road repair, temporary blocking, road congestion, or the like). In one example, when the mobile terminal detects that the destination is not reached and the current position is not changed within a certain time, the road abnormality information is automatically generated. In another example, when the user finds that the road ahead is abnormal during the driving along the global route, the user may input an instruction to the mobile terminal, and the mobile terminal transmits the road abnormality information to the cloud server according to the instruction.

Alternatively, the road abnormality information may be information issued when a navigation route is missing (for example, navigation is completed but the final destination is not reached). For example, the destination is a building in a campus, and the global route provided by the cloud server is the starting point to the gate of the campus, at this time, the mobile terminal may transmit the road abnormality information to the cloud server, automatically or after receiving the instruction of the user.

The current position of the mobile terminal may be detected by the mobile terminal and transmitted to the cloud server. For example, the mobile terminal may acquire the current position in real time in a GPS manner or the like during the driving of the user.

S14, acquiring a shared route in the cloud server, and generating at least one corrected route from the current position to the destination. The corrected route is different from an original remaining route (a route remaining in the original global route), and the original remaining route is a part of the global route, which is located between the current position of the mobile terminal and the destination. Alternatively, the shared routes may be shared by other mobile terminals to the cloud server.

The corrected route is different from the original remaining route, that is, the corrected route does not overlap with at least a portion of the original remaining route. For example, when an abnormal road segment (e.g., a blocked road segment, a repaired road segment, etc.) is stored on the original remaining route, the corrected route may be a route that bypasses the abnormal road segment.

The shared routes shared by the other mobile terminals to the cloud server may be shared routes shared by the other mobile terminals to the cloud server recently (for example, the last week, the last month, or the like).

For example, during the user is driving along the global path, it is found at a position A that the road ahead is temporarily blocked; at this time, the mobile terminal transmits the road abnormality information to the cloud server, and the cloud server compares the shared routes of other mobile terminals with the original remaining route in response to the road abnormality information. For example, when a certain shared route passes through the current position of the mobile terminal and the destination and is not identical to the remaining route, a portion of the shared route between the current position and the destination may be used as a corrected route.

In the embodiment of the present disclosure, when the user is driving according to the global route originally planned by the cloud server, but halfway encounters a problem such as a road abnormality (for example, road repair, temporary blocking, road congestion, or the like) or a navigation abnormality (for example, the navigation is finished but the final destination is not reached), the cloud server may generate the corrected route from the current position to the destination according to the shared routes shared by other mobile terminals to the cloud server in response to the road abnormality information transmitted by the mobile terminal, so that the user may reach the destination along the corrected route, improving the user experience.

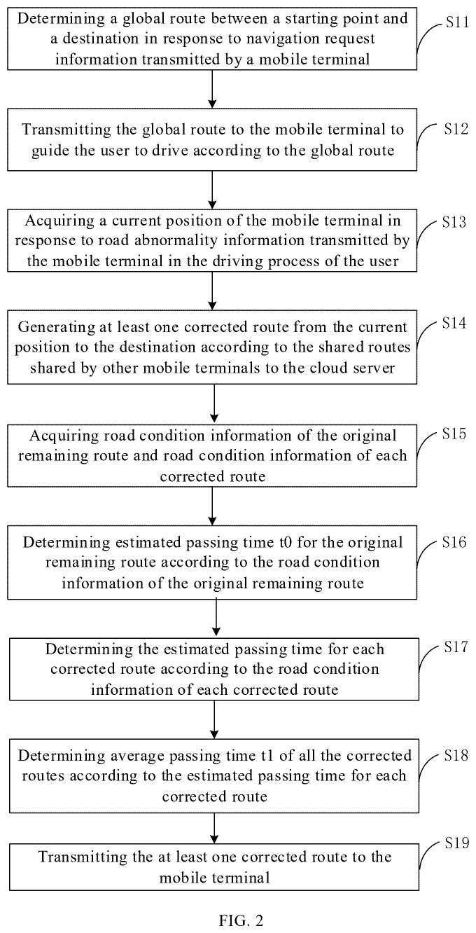

FIG. 2 is a schematic flow chart of a navigation method provided in further embodiments of the present disclosure. As shown in FIG. 2, the navigation method includes:

S11, determining a global route between a starting point and a destination in response to navigation request information transmitted by a mobile terminal, wherein the navigation request information includes at least information regarding the starting point and the destination.

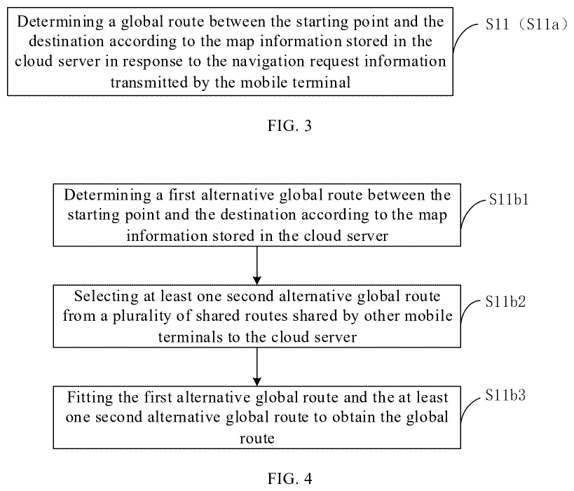

FIG. 3 is a schematic flow chart of step S11 provided in one example of the present disclosure. As shown in FIG. 3, in an example, the step S11 may specifically include: S11a, determining the global route between the starting point and the destination according to the map information stored in the cloud server in response to the navigation request information transmitted by the mobile terminal.

FIG. 4 is a schematic flow chart of step S11 provided in another example of the present disclosure. As shown in FIG. 4, in another example, the step S11 may specifically include: S11b1 to S11b3:

S11bi, determining a first alternative global route between the starting point and the destination according to the map information stored in the cloud server.

S11b2, selecting at least one second alternative global route from a plurality of shared routes shared by other mobile terminals to the cloud server, wherein the second alternative global route passes through a region defined by taking the destination as a center and a preset value as a radius.

The preset value may be determined according to actual requirements, for example, the preset value is 100 meters, 200 meters, or 500 meters.

S11b3, fitting the first alternative global route and at least one second alternative global route to obtain the global route.

For example, the first alternative global route is: a route from a location A to a location B through a location C; and the second alternative global route is: a route from a location D to the location B through the location C; a path between positions C and B in the second alternative global route is shorter than a path between positions C and B in the first alternative global route. In this case, a path between positions A and C in the first alternative global route and a path between positions C and B in the second alternative global route may be spliced together to obtain the global route.

In some scenarios, a user may wish to pass through one or more intermediate nodes during driving from the starting point to the destination, in which case, a corresponding instruction may be input to the mobile terminal, and the mobile terminal transmits the navigation request information to the cloud server according to the instruction, where the navigation request information includes, in addition to the information regarding the starting point and the destination, position information of at least one intermediate node between the starting point and the destination. The above step S11 may be implemented according to FIG. 5. FIG. 5 is a schematic flow chart of step S11 provided in yet another example of the present disclosure. As shown in FIG. 5, the step S11 includes the following steps S11c1 to S11c4:

S11c1, determining the first alternative global route between the starting point and the destination according to the map information stored in the cloud server.

S11c2, judging whether the first alternative global route passes through each intermediate node; if the first alternative global route passes through each intermediate node, S11c3 is performed. Otherwise, S11c4 is performed.

S11c3, taking the first alternative global route as the global route.

S11c4, selecting at least one second alternative global route from a plurality of shared routes shared by other mobile terminals to the cloud server; and fitting the at least one second alternative global route with the first alternative global route to generate the global route passing through each intermediate node.

In the embodiment shown in FIG. 5, the cloud server may generate the global route according to a specific requirement of a user, thereby improving the user experience.

With continued reference to FIG. 2, the navigation method further includes:

S12, transmitting the global route to the mobile terminal, to guide the user to drive according to the global route.

It should be noted that in step S11, a plurality of global routes may exist between the starting point and the destination, and the cloud server may determine an optimal (for example, the shortest time or the shortest distance) global route, or may transmit the plurality of global routes to the mobile terminal for selection by the user, and then transmit a corresponding global route to the mobile terminal according to the selection of the user.

S13, acquiring a current position of the mobile terminal in response to road abnormality information transmitted by the mobile terminal in the driving process of the user.

S14, generating at least one corrected route from the current position to the destination according to the shared routes shared by other mobile terminals to the cloud server. The corrected route is different from the original remaining route.

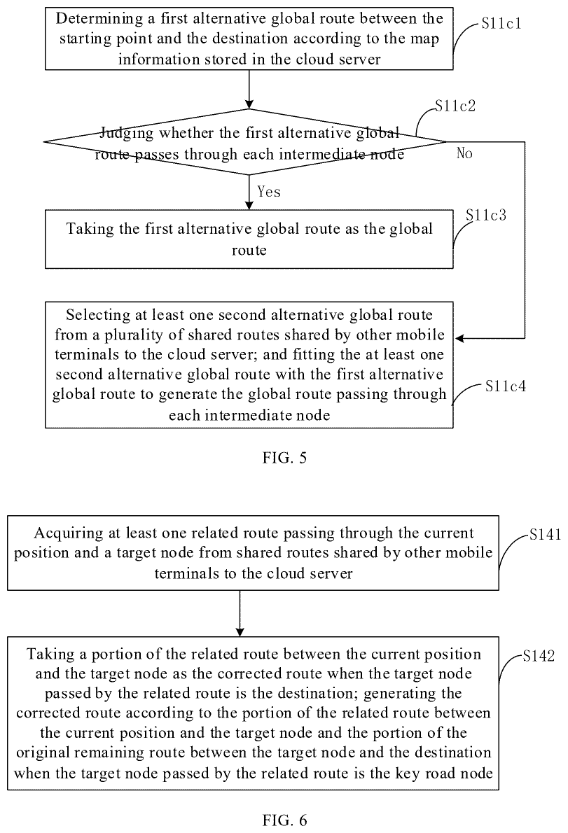

FIG. 6 is a schematic flow chart of step S14 provided in some embodiments of the present disclosure. As shown in FIG. 6, the step S14 may specifically include:

S141, acquiring at least one related route passing through the current position and a target node from shared routes shared by other mobile terminals to the cloud server, wherein the target node is the destination or a key road node positioned on the original remaining route, and the key road node is positioned in front of the destination and may be a road junction, a main trunk access, an entrance of the campus and other nodes.

S142, taking a portion of the related route between the current position and the target node as the corrected route when the target node passed by the related route is the destination; generating the corrected route according to the portion of the related route between the current position and the target node and the portion of the original remaining route between the target node and the destination when the target node passed by the related route is the key road node.

In some embodiments, before the S141, the method further includes: S140, detecting whether the abnormal road segment exists on the original remaining route, and if so, detecting the region where the abnormal road segment is located. In this case, the related route acquired in S141 needs to pass through the target node, and the target node should be located outside the abnormal road segment, so as to ensure that the corrected route obtained from the related route can completely avoid the abnormal road segment. “The target node is located outside the abnormal road segment” means that the target node has not any overlap with the abnormal road segment, or the target node is located at the end point of the abnormal road segment.

The abnormal road segment may be a congested road segment, a temporarily blocked road segment, or a road segment for repairing roads.

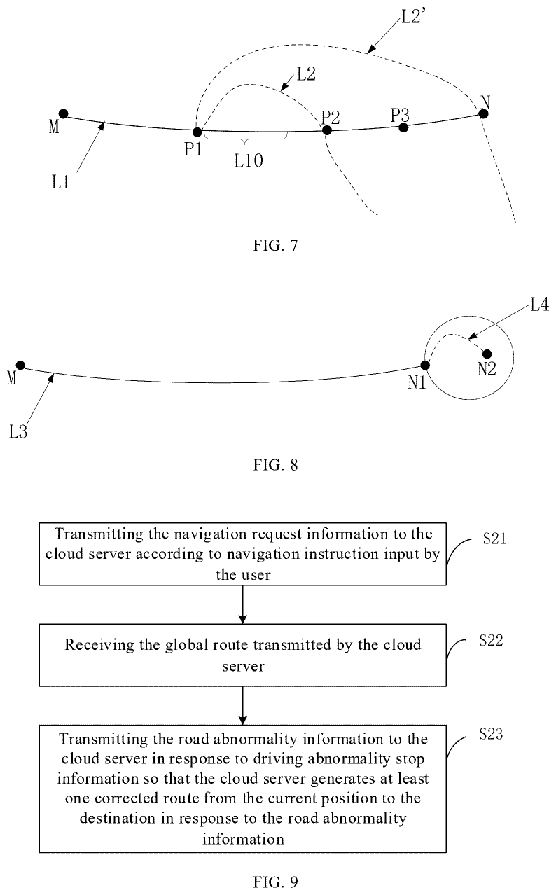

FIG. 7 is a schematic diagram of a global route and a corrected route provided in one example of the present disclosure. As shown in FIG. 7, in an example, the starting point is M, the destination is N, and a road segment L10 on the global route L1 between M and N is a temporarily blocked road segment. When the user finds that a road abnormality exists at a position P1 during driving along the global route L1, the mobile terminal transmits the road abnormality information to the cloud server. The cloud server detects that an abnormal road segment L10 exists on the original remaining route, key road nodes P2 and P3 also exist, and in the route recently shared by other mobile terminals to the cloud server, a related route L2 passing through the position P1 and the key road node P2 and another related route L2′ passing through the position P1 and the destination N exist. In this case, the cloud server may splice a portion of the related route L2 between P1 and P2 and a portion of the original remaining route between P2 and N to obtain a corrected route; a portion of the related route L2′ located between P1 and N is taken as another corrected route.

FIG. 8 is a schematic diagram of a global route and a corrected route provided in another example of the present disclosure. As shown in FIG. 8, in another example, a starting point is M, a destination is a certain building N2 in a campus N1, and in a global route L3 initially determined by the cloud server, the starting point is M, and the ending point is an entrance N1 of the campus. When the user drives to the entrance N1 of the campus along the global route L3, the user finds that there is a road abnormality (that is, there is no path from the entrance N1 of the campus to the building N2 in the global route L3), and at this time, the mobile terminal transmits the road abnormality information to the cloud server. In this case, since the original remaining route is empty, the cloud server may use the destination N2 as a target node, and assuming that there is a related route L4 (shown by a dotted line) passing through the current position (i.e., the entrance N1 of the campus) and the destination N2 in the route recently shared by other mobile terminals to the cloud server, the cloud server may use a portion of the related route L4 located between the campus entrance N1 and the destination N2 as a corrected route.

With continued reference to FIG. 2, the navigation method further includes:

S15, acquiring road condition information of the original remaining route and road condition information of each corrected route.

The road condition information may include: obstacle information, traffic information, the number of traffic lights, route distance, historical traffic flow, and the like on a road. The road condition information may be detected by a road test device around the road and transmitted to the cloud server.

S16, determining estimated passing time t0 for the original remaining route according to the road condition information of the original remaining route.

In one example, if congestion occurs on the original remaining route, the cloud server may determine the estimated passing time for the original remaining route (an estimated time period required to pass through the original remaining route) according to the traffic, the number of traffic lights, and a length of the original remaining route. In another example, when a fault such as road repair or temporary blocking occurs on the original remaining route, the cloud server may determine estimated solution time for the fault according to the type of the fault, and further determine the estimated passing time for the original remaining route according to the estimated solution time for the fault, lengths of other road segments in the original remaining route, the traffic, and the number of traffic lights.

S17, determining the estimated passing time for each corrected route according to the road condition information of each corrected route.

S18, determining average passing time t1 of all the corrected routes according to the estimated passing time for each corrected route.

S190, judging whether a ratio of the estimated passing time t0 to the average passing time t1 for the original remaining route exceeds a preset threshold, if so, executing a step S19.

S19, transmitting the at least one corrected route to the mobile terminal.

The preset threshold may be determined according to actual needs, for example, the preset threshold is 1.5, 2, 3 or the like.

In some embodiments, the step S19 may specifically include:

S191a, generating reminding information according to the estimated passing time t0 and the average passing time t1 for the original remaining route, and transmitting the reminding information to the mobile terminal, so that the mobile terminal outputs the reminding information to remind a user of changing the route. For example, the mobile terminal may output reminding information in a text and/or voice, where the reminding information may be “the current route is abnormal, the estimated passing time is t0, and the system recommends of changing the route with average passing time t1”.

S191b, selecting one of all the corrected routes as a recommended route according to a preset rule, and transmitting the recommended route to the mobile terminal.

For example, the preset rule may be: taking the corrected route which takes the shortest time as the recommended route, or taking the corrected route which has the shortest distance as the recommended route.

It should be noted that the step S19 may or may not include the step S191a. When the step S19 includes the step S191a, the cloud server may directly execute the step S191b after executing the step S191a. Alternatively, the cloud server may transmit query information together with the reminding information to the mobile terminal, and when receiving confirmation information for changing the route transmitted from the mobile terminal, the cloud server may then perform S191b.

In some examples, the cloud server may transmit the reminding information and the recommended route to the mobile terminal at the same time, or may transmit the recommended route to the mobile terminal after transmitting the reminding information and receiving the confirmation information for changing the route from the user.

In other embodiments, the step S19 may specifically include steps S192a to S192d:

S192a, generating reminding information according to the estimated passing time t0 and the average passing time t1 for the original remaining route, and transmitting the reminding information to the mobile terminal, so that the mobile terminal outputs the reminding information to remind a user of changing the route.

S192b, transmitting all the corrected routes to the mobile terminal.

S192c, selecting one of all the corrected routes as a recommended route in response to route selection information transmitted by the mobile terminal.

The route selection information may be generated by the mobile terminal in response to a selection instruction from the user. When the mobile terminal receives the corrected routes transmitted by the cloud server, all the corrected routes are displayed, and the user may select the corrected route according to the requirement and the preference of the user.

S192d, transmitting the recommended route to the mobile terminal.

Optionally, before step S192a, a characteristic tag of each corrected route may be generated according to the road condition information of each corrected route. When all the corrected routes are transmitted to the mobile terminal in step S192a, the characteristic tag of each corrected route may also be transmitted to the mobile terminal, so as to facilitate the selection by the user.

The characteristic tag may be a tag that characterizes characteristic information of the corrected route, such as “shortest time”, “shortest distance”, and “a less number of traffic lights”.

It should be noted that the step S19 may or may not include the step S192a. When the step S19 includes the step S192a, the cloud server may directly execute the step S192b after executing the step S192a. Alternatively, the cloud server may transmit query information together with the reminding information to the mobile terminal, and when receiving confirmation information for changing the route transmitted from the mobile terminal, the cloud server may then perform S192b.

In some embodiments, the navigation method further includes: updating the stored map information according to the route shared by the mobile terminal and in response to navigation end information, so that the map information is perfected. The navigation end information is used for representing that the mobile terminal reaches the destination. The information may be transmitted to the cloud server by the mobile terminal, for example, after the mobile terminal detects that a vehicle driven by the user is turned off for a period of time, and the navigation end information is generated. Alternatively, the navigation end information may be generated by the cloud server. For example, the mobile terminal transmits the current position to the cloud server in real time, and when the cloud server judges that the current position is consistent with the destination, the navigation end information is generated.

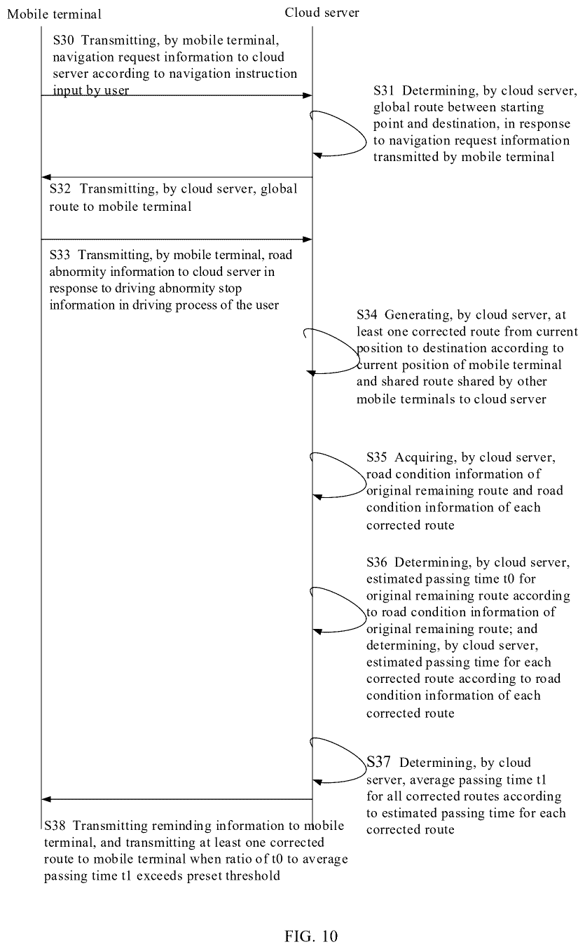

FIG. 9 is a schematic flow chart of a navigation method provided in further embodiments of the present disclosure. The navigation method shown in FIG. 9 is applied to a mobile terminal. As shown in FIG. 9, the navigation method includes the following steps performed by the mobile terminal:

S21, transmitting the navigation request information to the cloud server according to navigation instruction input by the user, so that the cloud server may determine the global route between the starting point and the destination; the navigation request information includes at least information regarding the starting point and the destination.

S22, receiving the global route transmitted by the cloud server.

S23, transmitting the road abnormality information to the cloud server in response to driving abnormality stop information, so that the cloud server acquires the current position of the mobile terminal and the shared route in the cloud server in response to the road abnormality information to generate at least one corrected route from the current position to the destination.

The corrected route is different from the original remaining route, the original remaining route is a portion of the global route between the current position and the destination.

The driving abnormality stop information may be input to the mobile terminal by the user. Alternatively, the driving abnormality stop information may be generated by the mobile terminal, for example, when the mobile terminal detects that the destination is not currently reached but the current position has not changed within a period of time, the driving abnormality stop information may be generated. The current position may be transmitted by the mobile terminal to the cloud server.

In some embodiments, when the navigation method performed by the cloud server includes step S192b, the navigation method performed by the mobile terminal further includes:

S24, receiving the corrected route transmitted by the cloud server.

S25, outputting an instruction acquisition request to request the user to input a selection instruction.

S26, transmitting the route selection information to the cloud server in response to the selection instruction input by the user, so that the cloud server selects one of all the corrected routes as the recommended route.

S27, receiving the recommended route transmitted by the cloud server.

In some embodiments, the navigation method further includes:

S28, outputting shared request information in response to the navigation end information, to request a user to confirm whether to upload the actual driving route to the cloud server. The navigation end information is used for representing that the mobile terminal reaches the destination, and may be generated by the cloud server and transmitted to the mobile terminal, or may be generated by a detection module of the mobile terminal.

S29, transmitting at least a part of the actual driving route to the cloud server in response to confirmation sharing information (confirmation information for sharing) input by the user.

The confirmation sharing information may include a length of the route to be shared. The user may input the length of the route to be shared to the mobile terminal according to actual conditions. For example, the user may select to share the whole actual driving route to the cloud server, or may upload a portion of the actual driving route to the cloud server. For example, a road segment closest to the end point and having a length of 100 meters is uploaded to the cloud server.

FIG. 10 is a schematic flow chart of a navigation method implemented by a navigation system provided in some embodiments of the present disclosure. As shown in FIG. 10, the navigation process includes:

S30, transmitting, by the mobile terminal, the navigation request information to the cloud server according to the navigation instruction input by the user, wherein the navigation request information at least includes information regarding the starting point and the destination.

S31, determining, by the cloud server, the global route between the starting point and the destination, in response to the navigation request information transmitted by the mobile terminal.

The specific manner of determining the global route by the cloud server has been described above, and is not described herein again.

S32, transmitting, by the cloud server, the global route to the mobile terminal so as to guide the user to drive along the global route.

S33, transmitting, by the mobile terminal, the road abnormity information to the cloud server in response to the driving abnormity stop information in the driving process;

S34, generating, by the cloud server, at least one corrected route from the current position to the destination according to the current position of the mobile terminal and the shared routes shared by other mobile terminals to the cloud server.

S35, acquiring, by the cloud server, the road condition information of the original remaining route and the road condition information of each corrected route.

S36, determining, by the cloud server, the estimated passing time t0 for the original remaining route according to the road condition information of the original remaining route; and determining, by the cloud server, the estimated passing time for each corrected route according to the road condition information of each corrected route.

S37, determining, by the cloud server, the average passing time t1 for all the corrected routes according to the estimated passing time for each corrected route.

S38, transmitting the reminding information to the mobile terminal, and transmitting at least one corrected route to the mobile terminal when the ratio of the t0 to the average passing time t1 exceeds the preset threshold.

The execution process of step S38 is described above with reference to S19, and is not described here again.

FIG. 15 is a flow chart of a computer-implemented navigation method provided in some embodiments of the present disclosure. As shown in FIG. 15, the navigation method includes the following steps S110 to S140:

S110, determining a global route between a starting point and a destination in response to navigation request information transmitted by a mobile terminal, wherein the navigation request information includes at least information regarding the starting point and the destination.

The navigation request information may be generated by the mobile terminal according to information such as addresses of the starting point and the destination input by the user. The cloud server may generate the global route from a built-in map, and the global route may include at least one shared route shared previously by one or more other mobile terminals to the cloud server.

S120, transmitting the global route to the mobile terminal, to guide the user to drive according to the global route.

S130, acquiring a current position of the mobile terminal in response to road abnormality information transmitted by any other mobile terminal in the driving process of the user as sharing information.

In this embodiment, the road abnormality information is road abnormality information transmitted by the other mobile terminal in the driving process of the user. The road abnormality information may be information transmitted by the other mobile terminal in the driving process when an abnormality (for example, road repair, temporary blocking, road congestion, or the like) occurs on the road ahead in the global route of the user. That is, in the driving process of the user according to the global route, an abnormality may occur on the road ahead of the user in the global route, and the other mobile terminal that first arrives the road and obtains, for example, a sudden unreported road abnormal condition and will then transmit the road abnormality information as sharing information to the cloud server to provide a warning to the user in real time. That is, when the user receives the road abnormality information found by the other mobile terminal that an abnormality occurs on the road ahead in the driving process in the global route, the user re-selects or re-create a navigation route according to the road abnormality information transmitted by the other mobile terminal to the cloud server.

The road abnormality information transmitted by the other mobile terminal may be congestion of a road ahead, for example, a water spot or a fallen tree on the road ahead due to raining or engineering construction, road closure due to temporary traffic control, or the like. The other mobile terminal shares the information as the sharing information to any other user when passing through the abnormal road condition in case that the navigation system does not give a prompt.

The current position of the user may be detected and transmitted to the cloud server by the mobile terminal. For example, the mobile terminal may obtain the current position in real time in a GPS manner or the like in the driving process of the user.

S140, generating at least one corrected route from the current position to the destination in response to confirmation of the sharing information (that is, this confirmation is done by the cloud server). The at least one corrected route is different from an original remaining route, and the original remaining route is a part of the global route between the current position and the destination. Optionally, the shared route may be shared by the other mobile terminal to the cloud server.

The corrected route is different from the original remaining route. That is, the corrected route does not overlap with at least a part of the original remaining route. For example, when an abnormal road segment associated with the road abnormality information (e.g., a blocked road segment, a repaired road segment, etc.) is included the original remaining route, the corrected route may be a route that bypasses the abnormal road segment.

The shared routes shared by the other mobile terminals to the cloud server may be shared routes shared by the other mobile terminals to the cloud server recently (for example, the last week, the last month, or the like).

For example, during the user is driving along the global path, the user of the other mobile terminal that firstly arrives a position A found that the road ahead is temporarily blocked; at this time, the other mobile terminal transmits the road abnormality information to the cloud server as the sharing information, and the cloud server compares the shared route of the other mobile terminal bypassing the abnormal road segment associated with the road abnormality information with the original remaining route in response to the road abnormality information. For example, when a shared route passes through the current position of the mobile terminal and the destination, and is not identical to the original remaining route, a part of the shared route between the current position and the destination may be used as a corrected route.

In the embodiment of the present disclosure, when the user is driving according to the global route originally planned by the cloud server, but halfway receives the road abnormality information transmitted by any other mobile terminal when encountering a road abnormality (for example, road repair, temporary blocking, road congestion, or the like), the cloud server may generate the corrected route from the current position to the destination, in response to the road abnormality information transmitted by the other mobile terminal, according to the shared route shared by the other mobile terminal to the cloud server when passing through the abnormal road segment (related to the road abnormality information transmitted by the other mobile terminal to the cloud server), or by integrating at least one shared route already included in the cloud server and the road abnormality information. The corrected route will guide the user to bypass the abnormal road segment associated with the road abnormality information transmitted by the other mobile terminal to the cloud server, so that the user can reach the destination along the corrected route, and bypass the abnormal road segment encountered by the other mobile terminal, improving the user experience.

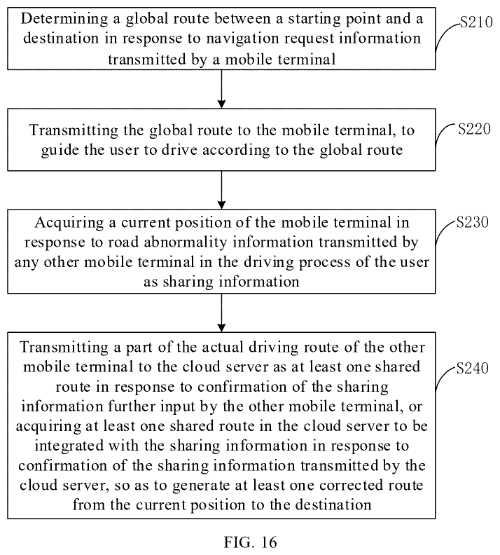

Specifically, as shown in FIG. 16, the computer-implemented navigation method of some embodiments of the present disclosure includes the following steps S210 to S240:

S210, determining a global route between a starting point and a destination in response to navigation request information transmitted by a mobile terminal.

S220, transmitting the global route to the mobile terminal, to guide the user to drive according to the global route.

S230, acquiring a current position of the mobile terminal in response to road abnormality information transmitted by other mobile terminal in the driving process of the user as sharing information.

S240, transmitting a part of an actual driving route of the other mobile terminal to the cloud server as at least one shared route in response to confirmation of the sharing information further input by the other mobile terminal (that is, this confirmation is done by the other mobile terminal), or acquiring at least one shared route by integrating at least one shared route already included in the cloud server and the road abnormality information in response to confirmation of the sharing information transmitted by the cloud server, so as to generate at least one corrected route from the current position to the destination.

In the embodiment, the other mobile terminal transmits the road abnormity information to the cloud server, and may further transmit at least a part of the actual driving route of the other mobile terminal bypassing the abnormal road segment related to the road abnormity information to the cloud server as a shared route for any other driver reference; or the other mobile terminal only provides the road abnormality information to the cloud server as the sharing information, and the cloud server executes confirmation of the sharing information and retrieves at least one shared route already included in the cloud server to be integrated with the road abnormality information. For example, the abnormal road segment related to the road abnormality information in the existing shared route is excluded or bypassed, and a nearest road segment or a fastest road segment is selected as the corrected route for any other driver reference so as to replace the abnormal road segment.

In addition, a shared route which does not include the abnormal road segment related to the road abnormality information shared by the other mobile terminal is selected from the existing shared routes in the cloud server as the corrected route.

In the above embodiment of the present disclosure, the road abnormality information transmitted by the other mobile terminal in the driving process of the user is considered, and the user may change the route according to the road abnormality information. That is, any possible change of information regarding the road ahead can be acquired in real time in the driving process of the user, so that the abnormal conditions on the route can be acquired as quickly as possible, and the driving route can be changed in real time.

In one embodiment, the road abnormality information obtained by the other mobile terminal in the driving process of the user may be a road abnormal condition on a conventional route transmitted by a public information platform (a broadcasting station or news), and is actively uploaded to the cloud server for a corrected route. With a real-time interaction with the cloud server, the user can obtain road abnormal condition information and be informed of the road abnormal condition in real time, and the user can decide whether to change the route. Alternatively, the user may make other selections (such as changing the destination and changing to another route), and the user may select the cloud server to recommend a shared route. The corrected route may include a shared route in the cloud server, which may be a shared route transmitted by the other mobile terminal. The shared route transmitted by the other mobile terminal is an actual driving route selected by the other mobile terminal after the user of the other terminal encountered the road abnormal condition in the previous driving process according to the encountered road abnormal condition, and the actual driving route selected based on the road abnormal condition existing in the conventional route is uploaded to the cloud server after the other mobile terminal finished the previous driving process.

In one embodiment, after the user arrives at the destination, the actual driving route excluding the abnormal road condition is uploaded to the cloud server as the shared route, the shared route includes the uploading time, and the road abnormal condition and the like. The cloud server manages, stores and recommends the shared route, screens the shared route according to a real-time condition, deletes or updates the shared route or the like. The other mobile terminal uploads the shared route including the road abnormal condition to the cloud server. The other mobile terminal uploads the road abnormal condition to the cloud server, and the cloud server constructs at least one shared route including the destination and further including characteristic nodes as alternative routes according to the road abnormal condition. The other mobile terminal uploads the road abnormal condition to the cloud server, provides a recommended route to a special destination according to the position of the road abnormal condition, and uploads the recommended route to the cloud server together with the road abnormal condition as the shared route. The road abnormal condition published by the user of the other mobile terminal in the driving process is shared with the cloud server in real time, and the road abnormal condition is published by the cloud server for any other driver reference in real time.

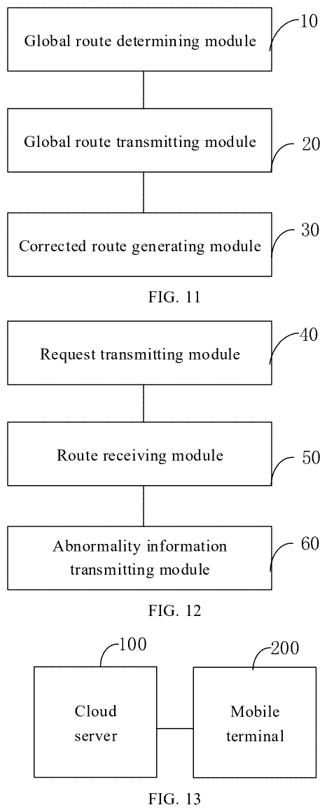

FIG. 11 is a schematic diagram of a cloud server provided in some embodiments of the present disclosure. The cloud server is configured to perform the above method illustrated in FIGS. 1 to 6. As shown in FIG. 11, the cloud server includes: a global route determining module 10, a global route transmitting module 20, a corrected route generating module 30.

The global route determining module 10 is configured to determine a global route between a starting point and a destination in response to navigation request information transmitted by a mobile terminal, wherein the navigation request information includes at least information regarding the starting point and the destination. The manner of determining the global route is described above, and is not described herein again.

The global route transmitting module 20 is configured to transmit the global route to the mobile terminal to guide a user to drive according to the global route.

The corrected route generating module 30 is configured to acquire a current position of the mobile terminal in response to road abnormality information transmitted by the mobile terminal in the driving process of the user; acquire a shared route in the cloud server, and generate at least one corrected route from the current position to the destination. The corrected route is different from an original remaining route, and the original remaining route is a part of the global route, which is located between the current position of the mobile terminal and the destination.

The manner of generating the corrected route by the corrected route generating module 30 is described above, and is not described herein again.

FIG. 12 is a schematic diagram of a mobile terminal provided in some embodiments of the present disclosure. The mobile terminal is configured to perform the method shown in FIG. 9. As shown in FIG. 12, the mobile terminal includes: a request transmitting module 40, a route receiving module 50 and an abnormality information transmitting module 60.

The request transmitting module 40 is configured to transmit the navigation request information to the cloud server according to navigation instruction input by the user, so that the cloud server may determine the global route between the starting point and the destination; the navigation request information includes at least information regarding the starting point and the destination.

The route receiving module 50 is configured to receive the global route transmitted by the cloud server.

The abnormality information transmitting module 60 is configured to transmit the road abnormality information to the cloud server in response to driving abnormality stop information, so that the cloud server acquires the current position of the mobile terminal in response to the road abnormality information and generate at least one corrected route from the current position to the destination according to the shared routes shared by other mobile terminals to the cloud server.

The original remaining route is a portion of the global route between the current position of the mobile terminal and the destination; the corrected route is different from the original remaining route.

In some embodiments, the route receiving module 50 is further configured to receive the corrected route transmitted by the cloud server. The mobile terminal further includes: an output module and an information transmitting module, wherein the output module is configured to output an instruction acquisition request to request a user to input a selection instruction. The information transmitting module is configured to transmit the route selection information to the cloud server in response to the selection instruction input by the user, so that the cloud server selects one of all the corrected routes as the recommended route. The route receiving module 50 is further configured to receive the recommended route transmitted by the cloud server.

In some embodiments, the output module is further configured to output shared request information in response to the navigation end information. The information transmitting module is further configured to transmit at least a part of the actual driving route to the cloud server in response to confirmation sharing information input by the user.

FIG. 13 is a schematic diagram of a navigation system provided in some embodiments of the present disclosure. The navigation system includes the cloud server shown in FIG. 11 and the mobile terminal shown in FIG. 12.

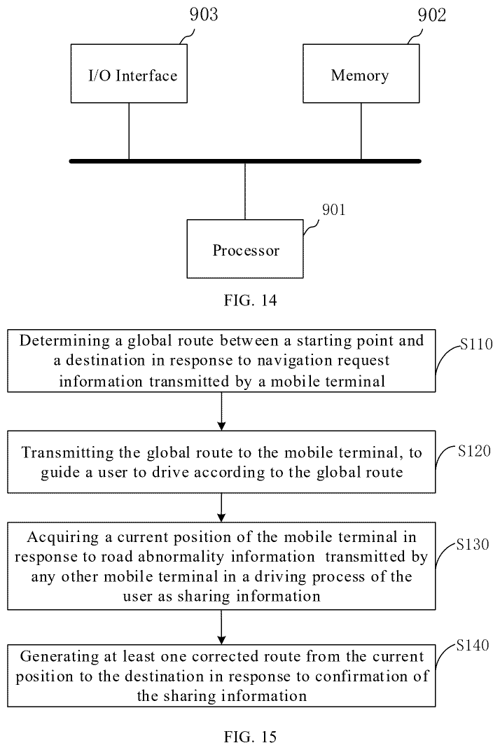

FIG. 14 is a schematic diagram of an electronic device provided in some embodiments of the present disclosure. As shown in FIG. 14, the electronic device includes: one or more processors 901; a memory 902 on which one or more programs are stored, which when executed by the one or more processors, cause the one or more processors to implement the navigation method described above; one or more I/O interfaces 903 connected between the one or more processors and the memory and configured to implement information interaction between the one or more processors and the memory.

Each processor 901 is a device with data processing capability, which includes, but is not limited to, a central processing unit (CPU), etc.; the memory 902 is a device with data storage capability, which includes, but is not limited to, random access memory (RAM, more specifically SDRAM, DDR, etc.), read only memory (ROM), electrically erasable programmable read only memory (EEPROM), flash memory (FLASH); the one or more I/O interfaces (read/write interfaces) 903 are connected between the one or more processors 901 and the memory 902 and are configured to enable information interaction between the one or more processors 901 and the memory 902, and include, but are not limited to, a data bus (Bus) etc.

In some embodiments, the one or more processors 901, the memory 902, and the one or more I/O interfaces 903 are connected to each other via the bus, which in turn are connected to other components of a computing device.

The present embodiment also provides a computer-readable medium, on which a computer program is stored, which when executed by a processor, implements the navigation method provided by the present embodiment.

One of ordinary skill in the art will appreciate that all or some of the steps, systems, functional modules/units in the devices, disclosed above may be implemented as software, firmware, hardware, and suitable combinations thereof. In a hardware implementation, the division between functional modules/units mentioned in the above description does not necessarily correspond to the division of physical components. For example, one physical component may have multiple functions, or one function or step may be performed by several physical components in cooperation. Some or all of the physical components may be implemented as software executed by a processor, such as a central processing unit, a digital signal processor, or a microprocessor, or as hardware, or as an integrated circuit, such as an application specific integrated circuit. Such software may be distributed on a computer-readable medium, for example, a computer storage medium (or non-transitory medium) and a communication medium (or a transitory medium). The computer storage medium includes a volatile, nonvolatile, removable, non-removable medium implemented in any method or technology for storage of information, such as computer readable instructions, data structures, program modules or other data, as is well known to one of ordinary skill in the art. The computer storage medium includes, but is not limited to, RAM, ROM, EEPROM, FLASH, or other disk storage; CD-ROM, Digital Versatile Disk (DVD), or other optical disk storage; magnetic cassettes, magnetic tape, magnetic disk storage or other magnetic storage; any other medium which may be used to store the desired information and which may be accessed by a computer. In addition, the communication medium typically embodies computer readable instructions, data structures, program modules or other data in a modulated data signal such as a carrier wave or other transport mechanism and includes any information delivery medium, as is well known to one of ordinary skill in the art.

It should be noted that in this document, the terms “comprising”, “including” or any other variation thereof are intended to cover a non-exclusive inclusion, such that a process, method, article, or apparatus that includes a list of elements does not include only those elements but may include other elements not expressly listed or inherent to such process, method, article, or apparatus. Without further limitation, an element defined by the phrase “including an . . . ” does not exclude the presence of other identical elements in the process, method, article, or apparatus that includes the element.

It should be understood that, the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

What is claimed is:

1. A computer-implemented navigation method for a cloud server, comprising:
determining a global route between a starting point and a destination in response to navigation request information transmitted by a mobile terminal, wherein the navigation request information includes at least information regarding the starting point and the destination;
transmitting the global route to the mobile terminal, to guide a user to drive according to the global route;
acquiring a current position of the mobile terminal in response to road abnormality information transmitted by any other mobile terminal in a driving process of the user as sharing information; and
generating at least one corrected route from the current position to the destination in response to confirmation of the sharing information, wherein the at least one corrected route is different from an original remaining route, and the original remaining route is a part of the global route between the current position and the destination.

2. The computer-implemented navigation method of claim 1, wherein the generating the at least one corrected route from the current position to the destination in response to confirmation of the sharing information comprises:
transmitting a part of an actual driving route of the other mobile terminal as at least one shared route to the cloud server, in response to confirmation of the sharing information further input by the other mobile terminal, to generate the at least one corrected route from the current position to the destination.

3. The computer-implemented navigation method of claim 1, wherein the generating the at least one corrected route from the current position to the destination in response to confirmation of the sharing information comprises:
acquiring at least one shared route in the cloud server, and integrating the road abnormity information with the at least one shared route in the cloud server, in response to confirmation of the sharing information transmitted by the cloud server, to generate the at least one corrected route from the current position to the destination.

4. The computer-implemented navigation method of claim 3, wherein the acquiring the at least one shared route in the cloud server, and the integrating the road abnormity information with the at least one shared route in the cloud server, to generate the at least one corrected route from the current position to the destination comprises:
acquiring one shared route, which is irrelevant with the road abnormity information, of a plurality of shared routes in the cloud server, to generate the at least one corrected route from the current position to the destination.

5. The computer-implemented navigation method of claim 3, wherein the acquiring the at least one shared route in the cloud server, and the integrating the road abnormity information with the at least one shared route in the cloud server, to generate the at least one corrected route from the current position to the destination comprises:
acquiring at least one related route passing through the current position and a target node and excluding the road abnormality information from the at least one shared route in the cloud server, wherein the target node is the destination or a key road node on the original remaining route;
taking a portion of the related route between the current position and the target node as the corrected route when the target node is the destination; and
generating the corrected route according to the portion of the related route between the current position and the target node and the portion of the original remaining route between the target node and the destination when the target node is the key road node.

6. The computer-implemented navigation method of claim 5, wherein before the acquiring the at least one related route passing through the current position and the target node, the computer-implemented navigation method further comprises:
detecting whether an abnormal road segment exists on the original remaining route; and detecting a region where the abnormal road segment is located in response to the abnormal road segment existing on the original remaining route; and
wherein the target node passed by the related route is located outside the abnormal road segment.

7. The computer-implemented navigation method of claim 1, wherein the computer-implemented navigation method further comprises:
acquiring road condition information of the original remaining route and road condition information of each corrected route;
determining estimated passing time for the original remaining route according to the road condition information of the original remaining route;
determining estimated passing time for each corrected route according to the road condition information of the corrected route;
determining average passing time of all the corrected routes according to the estimated passing times for all the corrected routes; and
transmitting the at least one corrected route to the mobile terminal in response to a ratio of the estimated passing time for the original remaining route to the average passing time exceeding a preset threshold.

8. The computer-implemented navigation method of claim 7, wherein the transmitting the at least one corrected route to the mobile terminal, comprises:
selecting one of all the corrected routes as a recommended route according to a preset rule, and transmitting the recommended route to the mobile terminal.

9. The computer-implemented navigation method of claim 7, wherein the transmitting the at least one corrected route to the mobile terminal, comprises:
transmitting all the corrected routes to the mobile terminal;
selecting one of all the corrected routes as a recommended route in response to route selection information transmitted by the mobile terminal; and
transmitting the recommended route to the mobile terminal.

10. A computer-implemented navigation method for a mobile terminal, wherein the computer-implemented navigation method comprises:
transmitting navigation request information to a cloud server according to navigation instruction input by a user, so that the cloud server determines a global route between a starting point and a destination; wherein the navigation request information comprises at least information regarding the starting point and the destination;
receiving the global route transmitted by the cloud server; and
acquiring, by the cloud server, a current position of the mobile terminal in response to road abnormality information transmitted by any other mobile terminal to the cloud server in a driving process of the user as sharing information, and generating, by the cloud server, at least one corrected route from the current position to the destination in response to confirmation of the sharing information;
wherein the at least one corrected route is different from an original remaining route, and the original remaining route is a part of the global route between the current position and the destination.

11. The computer-implemented navigation method of claim 10, wherein the generating the at least one corrected route from the current position to the destination in response to confirmation of the sharing information comprises:
transmitting a part of an actual driving route of the other mobile terminal as at least one shared route to the cloud server, in response to confirmation of the sharing information further input by the other mobile terminal, to generate the at least one corrected route from the current position to the destination.

12. The computer-implemented navigation method of claim 10, wherein the generating the at least one corrected route from the current position to the destination in response to confirmation of the sharing information comprises:
acquiring at least one shared route in the cloud server, and integrating the road abnormity information with the at least one shared route in the cloud server, in response to confirmation of the sharing information, to generate the at least one corrected route from the current position to the destination.

13. The computer-implemented navigation method of claim 12, wherein the acquiring the at least one shared route in the cloud server, and the integrating the road abnormity information with the at least one shared route in the cloud server, to generate the at least one corrected route from the current position to the destination comprises:
acquiring one shared route, which is irrelevant with the road abnormity information, of a plurality of shared routes in the cloud server, to generate the at least one corrected route from the current position to the destination.

14. The computer-implemented navigation method of claim 10, wherein the computer-implemented navigation method further comprises:
receiving the at least one corrected route transmitted by the cloud server;
outputting an instruction acquisition request to request the user to input selection instruction;
transmitting route selection information to the cloud server in response to the selection instruction input by the user, so that the cloud server selects one of the at least one corrected route as the recommended route; and
receiving the recommended route transmitted by the cloud server.

15. The computer-implemented navigation method of claim 10, wherein the computer-implemented navigation method further comprises:
outputting shared request information in response to navigation end information; and
transmitting at least a part of an actual driving route to the cloud server in response to confirmation of the sharing information input by the user.

16. A navigation system, comprising: a cloud server and a mobile terminal, wherein the cloud server comprises:
a global route determining module configured to determine a global route between a starting point and a destination in response to navigation request information transmitted by a mobile terminal, wherein the navigation request information comprises at least information regarding the starting point and the destination;
a global route transmitting module configured to transmit the global route to the mobile terminal to guide a user to drive according to the global route; and
a corrected route generating module configured to acquire a current position of the mobile terminal in response to road abnormality information transmitted by any other mobile terminal in a driving process of the user as sharing information, and generate at least one corrected route from the current position to the destination in response to confirmation of the sharing information; wherein the at least one corrected route is different from an original remaining route, and the original remaining route is a part of the global route between the current position and the destination;
the mobile terminal comprises:
a request transmitting module configured to transmit navigation request information to a cloud server according to navigation instruction input by a user, so that the cloud server determines a global route between a starting point and a destination; wherein the navigation request information comprises at least information regarding the starting point and the destination;
a route receiving module configured to receive the global route transmitted by the cloud server; and
an abnormality information transmitting module configured to cause road abnormality information transmitted by any other mobile terminal to the cloud server in a driving process of the user as sharing information, so that the cloud server acquires a current position of the mobile terminal in response to the road abnormality information, and generate at least one corrected route from the current position to the destination in response to confirmation of the sharing information;
wherein the at least one corrected route is different from an original remaining route, and the original remaining route is a part of the global route between the current position and the destination.

17. An electronic device, comprising:
one or more processors;
a memory having a computer program stored thereon that, when executed by the one or more processors, cause the one or more processors to implement the computer-implemented navigation method of claim 1; and
one or more I/O interfaces connected between the one or more processors and the memory and configured to enable information interaction between the one or more processors and the memory.

18. A nonvolatile computer-readable storage medium, on which a computer program is stored which, when being executed by a processor, implements the computer-implemented navigation method of claim 1.

19. An electronic device, comprising:
one or more processors;
a memory having a computer program stored thereon that, when executed by the one or more processors, cause the one or more processors to implement the computer-implemented navigation method of claim 10; and
one or more I/O interfaces connected between the one or more processors and the memory and configured to enable information interaction between the one or more processors and the memory.

20. A nonvolatile computer-readable storage medium, on which a computer program is stored which, when being executed by a processor, implements the computer-implemented navigation method of claim 10.
